(19) United States
(12) Patent Application Publication
(10) Pub. No.: US 2026/0128275 A1
(43) Pub. Date: May 7, 2026

(54) METHOD FOR MANUFACTURING LMFP COMPOSITE POSITIVE ELECTRODE PARTICLES

(71) Applicant: ZHI FENG LUO, Shenzhen (CN)

(72) Inventor: ZHI FENG LUO, Shenzhen (CN)

(21) Appl. No.: 18/939,562

(22) Filed: Nov. 7, 2024

(51) Int. Cl. H01M 4/04; H01M 4/02; H01M 4/36; H01M 4/58

(52) U.S. Cl. CPC H01M 4/0471; H01M 4/364; H01M 4/5825; H01M 2004/021

(57) ABSTRACT

A method for manufacturing LMFP composite positive electrode particles includes the steps of: placing a plurality of lithium ion conductor particles and LMFP particles, a carbon source and a first dispersant into a ball mill for mixing to form a mixed slurry, wherein each of the lithium ion conductor particles formed by a first oxide or phosphate capable of conducting lithium ions, or is formed by a second oxide with a garnet structure or a perovskite structure; then performing a drying on the mixed slurry to obtain a plurality of mixture powders; and then placing the mixture powders into a sintering furnace for performing an oxygen-free sintering to cause that the carbon source performs a dehydration reaction to produce carbons and other residues to form a conductive layer coated on the outer surface of each of the LMFP particles.

### FIELD OF THE INVENTION

The present invention is related to a positive electrode material for a battery, and in particular to a method for manufacturing LMFP composite positive electrode particles.

### BACKGROUND OF THE INVENTION

A typical battery includes a positive electrode and a negative electrode. A cathode of the battery is the positive electrode inside the battery. The positive electrode of a solid-state or semi-solid battery includes a positive electrode substrate and a positive electrode slurry layer. The positive electrode slurry layer includes a positive electrode slurry and a plurality of positive electrode particles. The positive electrode particles must be either additionally conductive or electrically conductive to allow free electrons to migrate through the positive electrode slurry without consuming too much energy due to internal resistance. Material of the positive electrode particles may be LMFP (lithium manganese iron phosphate), which has a better working voltage performance than LFP (lithium iron phosphate), releases higher energy density, is inexpensive, and is hydrophobic.

However, LMFP has a poor charge-discharge rate performance and a lower lithium ion conductivity and electrical conductivity, and it is prone to deterioration under prolonged battery use. Although there are many ways to increase the lithium ion conductivity of positive electrode particles, the electrical conductivity is still insufficient for practical use.

Therefore, the present invention desires to provide a novel invention to increase the electrical capacity and electrical conductivity of positive electrode of solid-state or semi-solid battery.

### SUMMARY OF THE INVENTION

Accordingly, for improving above mentioned defects in the prior art, the object of the present invention is to provide a method for manufacturing LMFP composite positive electrode particles, wherein the LMFP particle is coated by a conductive layer to increase the overall performance. The cost of LMFP is lower than the ternary oxide and the charge and discharge performance of LMFP can be applied to a specific range of applications. The conductive layer on the outer surface of the LMFP particle compensates for the lower conductivity of LMFP, and the LMFP particle are also coated with lithium ion conducting particles to enhance the overall lithium ion conductivity and electrical conductivity, resulting in a better battery performance.

To achieve above object, the present invention provides a method for manufacturing LMFP composite positive electrode particles; the composite positive electrode particles being used in a positive electrode of a solid-state or semi-solid battery; the method comprising the steps of: step A: placing a plurality of lithium ion conductor particles, a plurality of LMFP particles, a carbon source and a first dispersant into a ball mill for mixing to form a mixed slurry; wherein each of the lithium ion conductor particles is formed by a first oxide or phosphate capable of conducting lithium ions, or is formed by a second oxide with a garnet structure or a perovskite structure; a lithium ion conductivity of the first oxide or phosphate is higher than 10⁻⁵ S/cm (Siemens per centimeter); and the carbon source is formed by an organic compound capable of forming a conducting carbon structure under a reduction atmosphere; step B: performing a natural drying or a vacuum drying on the mixed slurry to obtain a plurality of mixture powders; step C: placing the mixture powders into a sintering furnace for performing an oxygen-free sintering on the mixture powders to form the composite positive electrode particles; wherein in the oxygen-free sintering, the carbon source in the mixture powders performs a dehydration reaction to produce carbons and other residues after the oxygen-free sintering; the carbons and residues remaining after the oxygen-free sintering form a conductive layer and the conductive layer is coated on an outer surface of each of the LMFP particles; and the lithium ion conductor particles on each of the LMFP particles form a continuous layer structure or a discontinuously dispersed structure or an island-shaped structure.

### BRIEF DESCRIPTION OF THE DRAWINGS

FIG. 1 is a steps flow diagram showing the process of the present invention.

FIG. 2 is a steps flow diagram showing the process of step A of the present invention.

FIG. 3 is a steps flow diagram showing the processes of step B to step E of the present invention.

FIG. 4 is a schematic view showing an application of the present invention.

FIG. 5 is a schematic view showing the full structure and a partial structure of the composite positive electrode particle of the present invention.

FIG. 6 is a cross-section view showing the structure of the composite positive electrode particle of the present invention.

FIG. 7 is a schematic view showing the carbon-material-coated composite positive electrode particle of the present invention.

FIG. 8 is a schematic view showing the lithium ion composite conductor particle of the present invention.

FIG. 9 is another cross-section view showing the structure of the composite positive electrode particle of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

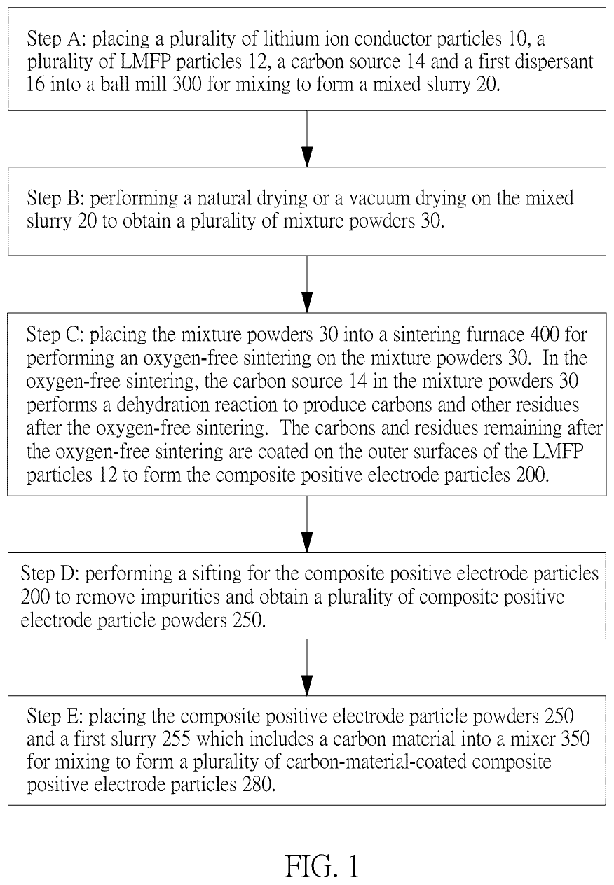

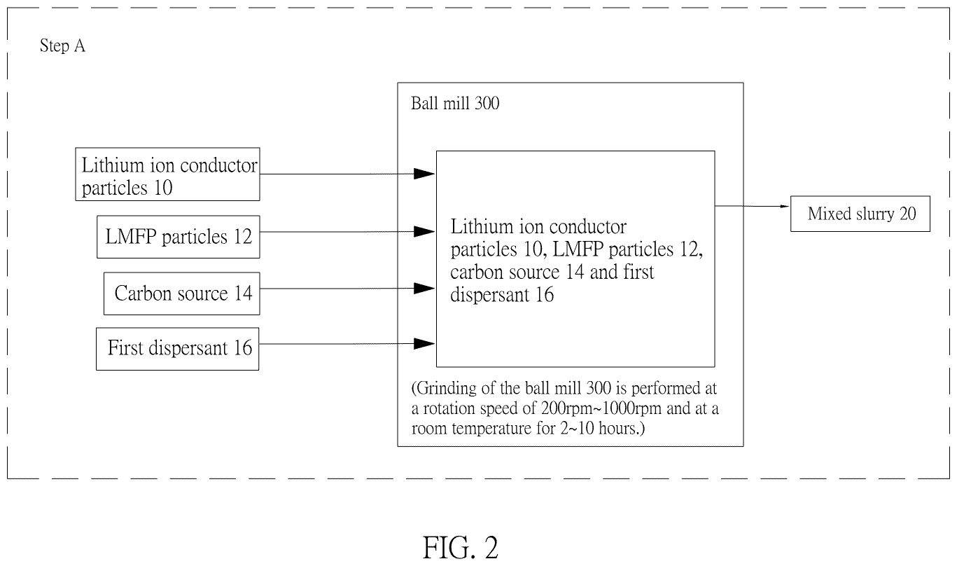

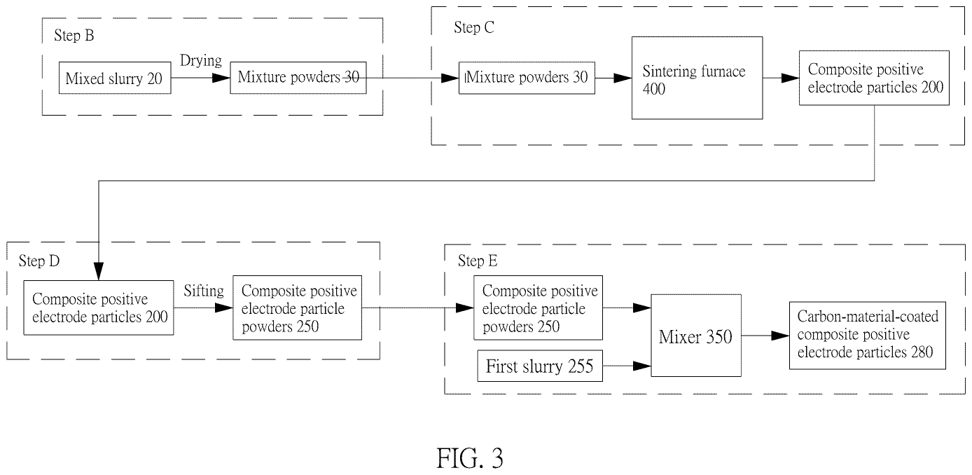

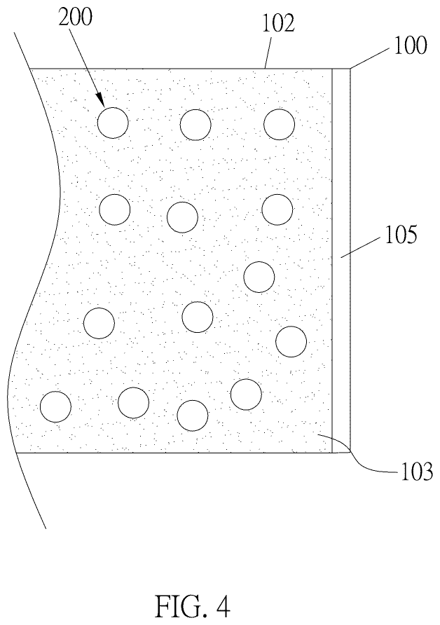

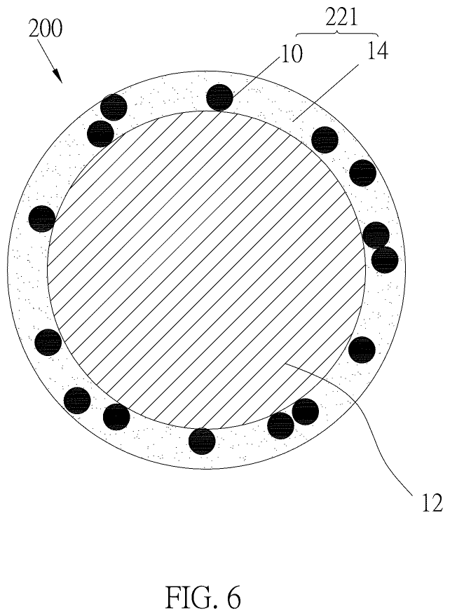

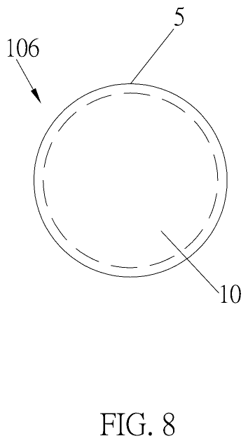

With reference to FIGS. 1 to 9, the present invention provides a method for manufacturing LMFP composite positive electrode particles 200. The composite positive electrode particles 200 are used in a positive (+) electrode 100 of a solid-state or semi-solid battery. The positive electrode 100 includes a positive electrode substrate 105 and a positive electrode slurry layer 102 coated on the positive electrode substrate 105 (as shown in FIG. 4). The positive electrode slurry layer 102 includes the composite positive electrode particles 200 and a positive electrode slurry 103 having a binder. A weight percentage of the composite positive electrode particles 200 in the positive electrode slurry layer 102 is 88 wt %˜98 wt %.

Referring to FIGS. 1 to 3, the method of the present invention comprises the following steps of:

Step A: placing a plurality of lithium ion conductor particles 10, a plurality of LMFP particles 12, a carbon source 14 and a first dispersant 16 into a ball mill 300 for mixing to form a mixed slurry 20.

Each of the lithium ion conductor particles 10 is formed by a first oxide or phosphate capable of conducting lithium ions, or is formed by a second oxide with a garnet structure or a perovskite structure. A lithium ion conductivity of the first oxide or phosphate is higher than 10⁻⁵ S/cm (Siemens per centimeter). The first oxide or phosphate with the lithium ion conductivity may be LATP (lithium aluminum titanium phosphate) with a NASICON (sodium (Na) super ionic conductor) structure, LAGP (lithium aluminium germanium phosphate), or lithiophosphate (Li₃PO₄). The second oxide with the garnet structure or the perovskite structure may be LLZO (Li₇La₃Zr₂O₁₂, lithium lanthanum zirconium oxide) or LLTO (lithium lanthanum titanium oxide). The lithium ion conductor particle 10 also can be formed by combination of above materials with any ratio.

A D50 (mass-median-diameter, MMD) value of each of the LMFP particles 12 is less than 1 μm. Each of the LMFP particles 12 is a polymer of monocrystalline materials or microcrystalline particles. Each of the LMFP particles 12 is formed by LMFP (lithium manganese iron phosphate, LiMnₓFe₁₋ₓPO₄, 0.1≤x≤0.8) or LMFP doped with at least one metal.

In the step A, before placing the lithium ion conductor particles 10 into the ball mill 300, an outer surface of each of the lithium ion conductor particles 10 is coated with a borate layer 5 to cause that the lithium ion conductor particles 10 form a plurality of lithium ion composite conductor particle 106. The borate layer 5 is formed by grinding the lithium ion conductor particles 10 to cause that the D50 value of each of the lithium ion conductor particles 10 is less than 200 nm, then mixing the lithium ion conductor particles 10 with a solution having boric acid to form a mixture, and then performing a drying and a grinding on the mixture or performing a drying, a sintering and a grinding on the mixture, causing that each of the outer surface of each of the lithium ion conductor particles 10 is coated with the borate layer 5. A size of each of lithium ion composite conductor particle 106 is less than or equal to 200 nm.

In the manufacturing of the composite positive electrode particle 200, an oxygen-free sintering will be performed. In the oxygen-free sintering, the conductivity of the lithium ion conductor particles 10 will be decreased due to the lithium deficiency caused by oxygen lacking. Therefore, the borate layer 5 is coated on the outer surface of the lithium ion conductor particles 10 to be used as a protective layer, which prevents the structure of the lithium ion conductor particles 10 from being damaged.

The carbon source 14 is formed by an organic compound capable of forming a conducting carbon structure under a reduction atmosphere. The organic compound is selected from carbohydrate (such as monosaccharide, disaccharide, oligosaccharide or polysaccharide), water-soluble fiber and amino acid polymer. Preferably, the organic compound is a compound including carbon, nitrogen, fluorine, phosphorus and sulfur, wherein the nitrogen, fluorine, phosphorus and sulfur are doped to the carbon by a reduction reaction, which increases the electrical conductivity of the composite positive electrode particle 200.

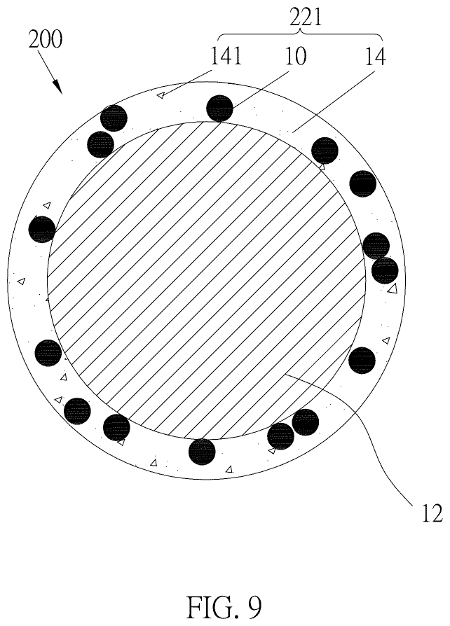

Referring to FIG. 9, the carbon source 14 further includes a plurality of conductive carbons 141 capable of being dispersed within the first dispersant 16. The conductive carbons 124 are formed by at least one of graphite, graphene, nanoscale amorphous carbons, and carbon nanotubes with a length less than or equal to 1 μm. When the carbon source 14 includes the carbon nanotubes, a weight percentage of the carbon nanotubes in the carbon source 14 is less than or equal to 10 wt %.

A ratio of a weight of the carbon source 14 and a total weight of the lithium ion conductor particles 10 is 10:1 to 1:10. The first dispersant 16 is formed by at least one of water, ethanol and isopropyl alcohol.

A quotient of a ratio of the total weight of the lithium ion conductor particles 10 and a total weight of the LMFP particles 12 is less than or equal to 0.02 (that is the ratio is not higher than 2:100). A quotient of a ratio of the weight of the carbon source 14 and the weight of the LMFP particles 12 is less than or equal to 0.01 (that is the ratio is not higher than 1:100). A weight percentage of the lithium ion conductor particles 10, the LMFP particles 12 and the carbon source 14 in the mixed slurry 20 is less than or equal to 35 wt %.

Preferably, each of the lithium ion conductor particles 10 is formed by at least one of LLZO (Li₇La₃Zr₂O₁₂), Ga-LLZO (gallium-doped LLZO), Cu-LLZO (copper-doped LLZO), Ta-LLZO (tantalum-doped LLZO), Sr-LLZO (strontium-doped LLZO) and Al-LLZO (aluminum-doped LLZO).

Preferably, each of the lithium ion conductor particles 10 is formed by Cuₐ, X_{b}-LLZO, which is LLZO doped with copper (Cu) and a metal X, wherein X is selected from gallium (Ga), tantalum (Ta), strontium (Sr), barium (Ba) and aluminum (Al), and a>0 and b>0. Preferably, a+b=0.25˜0.8 and a>0.1. Doping the copper in the LLZO is technically difficult, but Cuₐ, X_{b}-LLZO can stabilize an overall structure, smooth the channels for lithium ions, and increase a speed of the sintering, which makes the cost more cheaper. It also reduces the producing of lithium carbonate (Li₂CO₃) when being exposed to the air, which increases the surface stability during the sintering.

When each of the lithium ion conductor particles 10 is formed by LAGP or LATP, the LAGP or LATP is selected from Li₁₊ₓAlₓA₂₋ₓ(PO₄)₃ or Li_{1+x+y}AlₓA_{2-x-y-z}M_{y}N_{z}(PO₄)₃, wherein 0.1≤x≤0.8, 0≤y≤0.2, 0≤z≤0.2, A is germanium (Ge) or titanium (Ti), M is trivalent cation (such as scandium cation (Sc³⁺), yttrium cation (Y³⁺), gallium cation (Ga³⁺), indium cation (In³⁺) or lanthanum cation (La³⁺)), and N is tetravalent cation (such as zirconium cation (Zr⁴⁺), silicon cation (Si⁴⁺), or tin cation (Sn⁴⁺)).

The ball mill 300 is a wet ball mill, wherein the wet ball mill is a blade ball mill or a ball mill with zirconium balls. In the step A, a rotation speed of the ball mill 300 is 200 rpm˜1000 rpm. A grinding time of the ball mill 300 is 2 to 10 hours. A grinding temperature of the ball mill 300 is a room temperature.

Step B: performing a natural drying or a vacuum drying on the mixed slurry 20 to obtain a plurality of mixture powders 30.

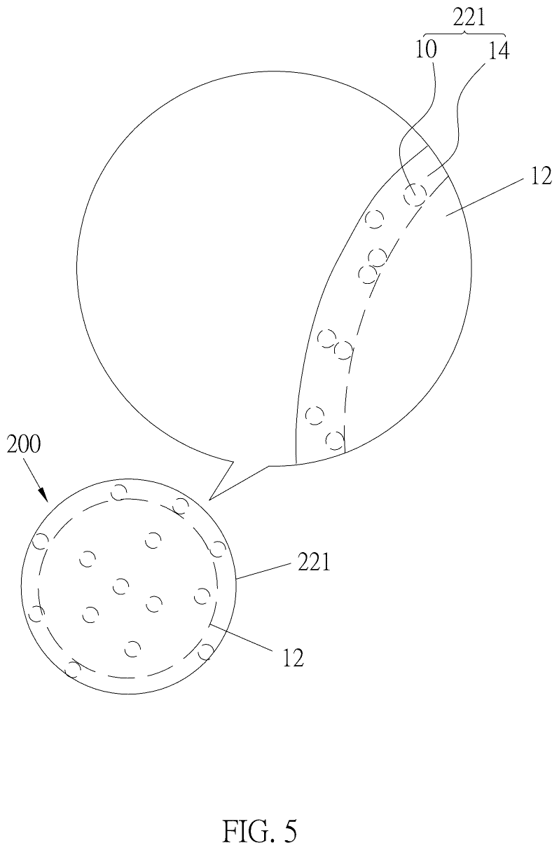

Step C: placing the mixture powders 30 into a sintering furnace 400 for performing an oxygen-free sintering on the mixture powders 30. In the oxygen-free sintering, the carbon source 14 in the mixture powders 30 performs a dehydration reaction to produce carbons and other residues after the oxygen-free sintering. The carbons and residues remaining after the oxygen-free sintering are coated on the outer surface of each of the LMFP particles 12 (as shown in FIG. 5).

In the oxygen-free sintering, when the carbon source 14 is formed by carbohydrates, the carbons are left behind after a dehydration reaction of the carbohydrates. When the carbon source 14 is formed by water-soluble fibers, carbon skeletons and functional groups (such as sulfur, nitrogen or halogen) are left behind after a dehydration reaction of the water-soluble fibers. A structure of the carbon skeletons is determined by a structure of the original water-soluble fibers. When the carbon source 14 is formed by amino acid polymers, carbon skeletons with straight chains or side chains containing doping elements are left behind after a dehydration reaction of the amino acid polymers. When the carbon source 14 includes the conductive carbons 141 (which are formed by graphite, graphene, nanoscale amorphous carbons or carbon nanotubes), a structure of each of the conductive carbons 141 is not changed and are remained with an original form after the oxygen-free sintering.

In the oxygen-free sintering, the outer surface of each of the LMFP particles 12 is coated with a conductive layer 221 which is formed by the lithium ion conductor particles 10 and the carbon source 14 (that is, the carbons and other residues produced after the dehydration reaction of the carbon source 14) to form the composite positive electrode particles 200. A thickness of the conductive layer 221 is less than or equal to 200 nm. The lithium ion conductor particles 10 on each of the LMFP particles 121 form a continuous layer structure or a discontinuously dispersed structure or an island-shaped structure.

In the step C, a sintering temperature of the sintering furnace 400 is 400° C.˜700° C. A sintering time of the sintering furnace 400 is 1 to 10 hours. The oxygen-free sintering is a vacuum sintering, or is a sintering under a protective atmosphere (such as a sintering under a protective atmosphere formed by argon (Ar) & nitrogen (N₂)).

Step D: performing a sifting for the composite positive electrode particles 200 to remove impurities and obtain a plurality of composite positive electrode particle powders 250.

The present invention further comprises the following step of:

Step E: placing the composite positive electrode particle powders 250 and a first slurry 255 which includes a carbon material into a mixer 350 for mixing to form a plurality of carbon-material-coated composite positive electrode particles 280. A solvent in the first slurry 255 is selected from water, ethanol, isopropyl alcohol and NMP (N-Methyl-2-pyrrolidone). A weight percentage of the carbon material in the first slurry 255 is less than or equal to 5 wt %. The first slurry 255 may further include a second dispersant, wherein the second dispersant is selected from SCS (sodium o-cumenesulfonate) and sinapinic acid. A weight percentage of the second dispersant in the first slurry 255 is less than or equal to 1 wt %. The carbon material includes a plurality of first carbon nanotubes 40 and a plurality of nanoscale amorphous carbons 45. A rotation speed of the mixer 350 is 50 rpm˜1000 rpm. A mixing time of the mixer 350 is 1 to 3 hours. The mixer 350 is a DC stirrer or a vacuum emulsifying mixer.

The first carbon nanotubes 40 include a plurality of short chain carbon nanotubes 42 and a plurality of long chain carbon nanotubes 44. A length of each of the short chain carbon nanotubes 42 is 0.2 μm to 1 μm. A length of each of the long chain carbon nanotubes 44 is 1 μm to 3 μm. A ratio of a weight of the short chain carbon nanotubes 42 and a weight of the long chain carbon nanotubes 44 is 10:1 to 2:1. A quotient of a ratio of a total weight of the carbon material of the first slurry 255 and a weight of the composite positive electrode particle powders 250 is less than or equal to 0.01 (that is, the ratio is not higher than 1:100). A ratio of a weight of the first carbon nanotubes 40 and a weight of the nanoscale amorphous carbons 45 is 1:1 to 1:10. A size of each of the nanoscale amorphous carbons 45 is 10 nm to 40 nm.

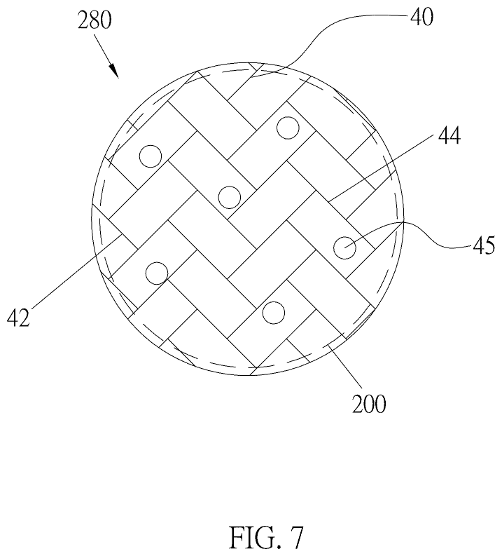

Different lengths of the first carbon nanotubes 40 form different levels of spanning on the composite positive electrode particle 200. The short chain carbon nanotubes 42 are connected across between the lithium ion conductor particles 10 and the LMFP particle 12. The long chain carbon nanotubes 44 cover the composite positive electrode particle 200 to enhance a structural strength of the composite positive electrode particle 200. The composite positive electrode particle 200 covered by the first carbon nanotubes 40 forms a hairball-like structure (as shown in FIG. 7).

The first carbon nanotubes 40 serve to form conductive bridges around the composite positive electrode particle 200 for conducting the electron on the composite positive electrode particle 200. The first carbon nanotubes 40 have an extremely high electrical conductivity, so that lithium ions can pass through the first carbon nanotubes 40 and conduct between different composite positive electrode particles 200, which increase the electrical conductivity of the entire positive electrode 100.

Preferably, the nanoscale amorphous carbons 45 are amorphous carbons of a Super P auxiliary agent. The first carbon nanotubes 40 and the nanoscale amorphous carbons 45 are used as an auxiliary agent. The nanoscale amorphous carbons 45 are in a form of particles, and the first carbon nanotubes 40 are in a form of long strips, and the nanoscale amorphous carbons 45 are filled in the gaps formed in the interleaving first carbon nanotubes 40 to transmit the electric charge between the first carbon nanotubes 40 through the spanning of the nanoscale amorphous carbons 45, which further increases the transmitting efficiency of the electric current.

The advantages of the present invention are that, the LMFP particle is coated by a conductive layer to increase the overall performance. The cost of LMFP is lower than the ternary oxide and the charge and discharge performance of LMFP can be applied to a specific range of applications. The conductive layer on the outer surface of the LMFP particle compensates for the lower conductivity of LMFP, and the LMFP particle are also coated with lithium ion conducting particles to enhance the overall lithium ion conductivity and electrical conductivity, resulting in a better battery performance.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for manufacturing LMFP composite positive electrode particles; the composite positive electrode particles being used in a positive electrode of a solid-state or semi-solid battery; the method comprising the steps of:
step A: placing a plurality of lithium ion conductor particles, a plurality of LMFP particles, a carbon source and a first dispersant into a ball mill for mixing to form a mixed slurry; wherein each of the lithium ion conductor particles is formed by a first oxide or phosphate capable of conducting lithium ions, or is formed by a second oxide with a garnet structure or a perovskite structure; a lithium ion conductivity of the first oxide or phosphate is higher than 10⁻⁵ S/cm (Siemens per centimeter); and
the carbon source is formed by an organic compound capable of forming a conducting carbon structure under a reduction atmosphere;
step B: performing a natural drying or a vacuum drying on the mixed slurry to obtain a plurality of mixture powders;
step C: placing the mixture powders into a sintering furnace for performing an oxygen-free sintering on the mixture powders to form the composite positive electrode particles; wherein in the oxygen-free sintering, the carbon source in the mixture powders performs a dehydration reaction to produce carbons and other residues after the oxygen-free sintering; the carbons and residues remaining after the oxygen-free sintering form a conductive layer and the conductive layer is coated on an outer surface of each of the LMFP particles; and the lithium ion conductor particles on each of the LMFP particles form a continuous layer structure or a discontinuously dispersed structure or an island-shaped structure.

2. The method for manufacturing the LMFP composite positive electrode particles as claimed in claim 1, wherein the first oxide or phosphate with the lithium ion conductivity may be LATP (lithium aluminum titanium phosphate) with a NASICON (sodium (Na) super ionic conductor) structure, LAGP (lithium aluminium germanium phosphate), or lithiophosphate (Li₃PO₄).

3. The method for manufacturing the LMFP composite positive electrode particles as claimed in claim 1, wherein the second oxide with the garnet structure or the perovskite structure may be LLZO (Li₇La₃Zr₂O₁₂, lithium lanthanum zirconium oxide) or LLTO (lithium lanthanum titanium oxide).

4. The method for manufacturing the LMFP composite positive electrode particles as claimed in claim 1, wherein a D50 (mass-median-diameter, MMD) value of each of the LMFP particles is less than 1 μm; and each of the LMFP particles is a polymer of monocrystalline materials or microcrystalline particles; and a thickness of the conductive layer is less than or equal to 200 nm.

5. The method for manufacturing the LMFP composite positive electrode particles as claimed in claim 1, wherein each of the LMFP particles is formed by LMFP (lithium manganese iron phosphate, LiMnₓFe₁₋ₓPO₄, 0.1≤x≤0.8) or LMFP doped with at least one metal.

6. The method for manufacturing the LMFP composite positive electrode particles as claimed in claim 1, wherein in the step A, before placing the lithium ion conductor particles into the ball mill, an outer surface of each of the lithium ion conductor particles is coated with a borate layer to cause that the lithium ion conductor particles form a plurality of lithium ion composite conductor particle.

7. The method for manufacturing the LMFP composite positive electrode particles as claimed in claim 6, wherein the borate layer is formed by grinding the lithium ion conductor particles to cause that the D50 value of each of the lithium ion conductor particles is less than 200 nm, then mixing the lithium ion conductor particles with a solution having boric acid to form a mixture, and then performing a drying and a grinding on the mixture or performing a drying, a sintering and a grinding on the mixture, causing that each of the outer surface of each of the lithium ion conductor particles is coated with the borate layer.

8. The method for manufacturing the LMFP composite positive electrode particles as claimed in claim 1, wherein the organic compound is selected from monosaccharide, disaccharide, oligosaccharide and polysaccharide, water-soluble fiber and amino acid polymer;
wherein in the oxygen-free sintering of the step C, when the carbon source is formed by carbohydrates, the carbons are left behind after a dehydration reaction of the carbohydrates; when the carbon source is formed by water-soluble fibers, carbon skeletons and functional groups are left behind after a dehydration reaction of the water-soluble fibers; a structure of the carbon skeletons is determined by a structure of the original water-soluble fibers; and when the carbon source is formed by amino acid polymers, carbon skeletons with straight chains or side chains containing doping elements are left behind after a dehydration reaction of the amino acid polymers.

9. The method for manufacturing the LMFP composite positive electrode particles as claimed in claim 1, wherein the organic compound is a compound including carbon, nitrogen, fluorine, phosphorus and sulfur, wherein the nitrogen, fluorine, phosphorus and sulfur are doped to the carbon by a reduction reaction.

10. The method for manufacturing the LMFP composite positive electrode particles as claimed in claim 1, wherein the carbon source further includes at least one of graphite, graphene, nanoscale amorphous carbons, and carbon nanotubes with a length less than or equal to 1 μm.

11. The method for manufacturing the LMFP composite positive electrode particles as claimed in claim 1, wherein a ratio of a weight of the carbon source and a total weight of the lithium ion conductor particles is 10:1 to 1:10; a quotient of a ratio of a total weight of the lithium ion conductor particles and a total weight of the LMFP particles is less than or equal to 0.02; a quotient of a ratio of a weight of the carbon source and the total weight of the LMFP particles is less than or equal to 0.01; and a weight percentage of the lithium ion conductor particles, the LMFP particles and the carbon source in the mixed slurry is less than or equal to 35 wt %.

12. The method for manufacturing the LMFP composite positive electrode particles as claimed in claim 1, wherein each of the lithium ion conductor particles is formed by at least one of LLZO (Li₇La₃Zr₂O₁₂), Ga-LLZO (gallium-doped LLZO), Cu-LLZO (copper-doped LLZO), Ta-LLZO (tantalum-doped LLZO), Sr-LLZO (strontium-doped LLZO) and Al-LLZO (aluminum-doped LLZO).

13. The method for manufacturing the LMFP composite positive electrode particles as claimed in claim 1, wherein each of the lithium ion conductor particles is formed by Cuₐ,X_{b}-LLZO, which is LLZO doped with copper (Cu) and a metal X, wherein X is selected from gallium (Ga), tantalum (Ta), strontium (Sr), barium (Ba) and aluminum (Al), a+b=0.25˜0.8 and a>0.1.

14. The method for manufacturing the LMFP composite positive electrode particles as claimed in claim 1, wherein when each of the lithium ion conductor particles is formed by LAGP (lithium aluminium germanium phosphate) or LATP (lithium aluminum titanium phosphate), the LAGP or LATP is selected from Li₁₊ₓAlₓA₂₋ₓ(PO₄)₃ or Li_{1+x+y}AlₓA_{2-x-y-z}M_{y}N_{z}(PO₄)₃, wherein 0.1≤x≤0.8, 0≤y≤0.2, 0≤z≤0.2, A is germanium (Ge) or titanium (Ti), M is trivalent cation, and N is tetravalent cation.

15. The method for manufacturing the LMFP composite positive electrode particles as claimed in claim 1, wherein the ball mill is a wet ball mill, wherein the wet ball mill is a blade ball mill or a ball mill with zirconium balls; in the step A, a rotation speed of the ball mill is 200 rpm˜1000 rpm; a grinding time of the ball mill is 2 to 10 hours; and a grinding temperature of the ball mill is a room temperature.

16. The method for manufacturing the LMFP composite positive electrode particles as claimed in claim 1, wherein in the step C, a sintering temperature of the sintering furnace is 400° C.˜700° C.; a sintering time of the sintering furnace is 1 to 10 hours; and the oxygen-free sintering is a vacuum sintering or is a sintering under a protective atmosphere.

17. The method for manufacturing the LMFP composite positive electrode particles as claimed in claim 1, further comprising the step of:
step D: performing a sifting for the composite positive electrode particles to remove impurities and obtain a plurality of composite positive electrode particle powders.

18. The method for manufacturing the LMFP composite positive electrode particles as claimed in claim 17, further comprising the step of:
step E: placing the composite positive electrode particle powders and a first slurry which includes a carbon material into a mixer for mixing to form a plurality of carbon-material-coated composite positive electrode particles; and wherein the carbon material includes a plurality of first carbon nanotubes and a plurality of nanoscale amorphous carbons.

19. The method for manufacturing the LMFP composite positive electrode particles as claimed in claim 18, wherein in the step E, a rotation speed of the mixer is 50 rpm˜1000 rpm; a mixing time of the mixer is 1 to 3 hours; and the mixer is a DC stirrer or a vacuum emulsifying mixer.

20. The method for manufacturing the LMFP composite positive electrode particles as claimed in claim 18, wherein a weight percentage of the carbon material in the first slurry is less than or equal to 5 wt %; a solvent in the first slurry is selected from water, ethanol, isopropyl alcohol and NMP (N-Methyl-2-pyrrolidone); the first slurry further includes a second dispersant, wherein the second dispersant is selected from SCS (sodium o-cumenesulfonate) and sinapinic acid; and a weight percentage of the second dispersant in the first slurry is less than or equal to 1 wt %; the first carbon nanotubes include a plurality of short chain carbon nanotubes and a plurality of long chain carbon nanotubes; a length of each of the short chain carbon nanotubes is 0.2 μm to 1 μm; a length of each of the long chain carbon nanotubes is 1 μm to 3 μm; and a size of each of the nanoscale amorphous carbons is 10 nm to 40 nm.
